(19) United States
(12) Patent Application Publication
(10) Pub. No.: US 2024/0301152 A1
(43) Pub. Date: Sep. 12, 2024

(54) WATER-SOLUBLE FILMS AND PACKAGES

(71) Applicant: Reckitt Benckiser Finish B.V., Hoofddorp (NL)

(72) Inventors: Alias Younis AL-BAYATI, Heidelberg (DE); Sascha FUHRMANN, Heidelberg (DE); Axel HALBHERR, Heidelberg (DE); Naomi MARKHAM, Heidelberg (DE); Claudia SCHMAELZLE, Heidelberg (DE)

(21) Appl. No.: 18/566,021

(22) PCT Filed: May 31, 2022
(86) PCT No.: PCT/EP2022/064721

§ 371 Date: Nov. 30, 2023

(30) Foreign Application Priority Data
Jun. 3, 2021 (GB) 2107974.4

(51) Int. Cl. C08J 5/18; B65D 65/46; B65D 75/32; C08K 5/053; C11D 17/04

(52) U.S. Cl. CPC C08J 5/18; B65D 65/46; B65D 75/326; B65D 75/327; C08K 5/053; C11D 17/045; C08J 2329/04

(57) ABSTRACT

The invention relates to a water-soluble film comprising more than one polyvinyl alcohol resin and at least one plasticiser present in an amount of at least 20% by weight of the film, wherein at least one polyvinyl alcohol resin has a weight average molecular weight of at least 50,000 g/mol and at least one polyvinyl alcohol resin has a weight average molecular weight of less than 50,000 g/mol.

The invention is further related to a direct cast extrusion process for producing a water-soluble film comprising more than one polyvinyl alcohol resin and at least one plasticiser present in an amount of at least 20% by weight of the film, wherein at least one polyvinyl alcohol resin has a weight average molecular weight of at least 50,000 g/mol and at least one polyvinyl alcohol resin has a weight average molecular weight of less than 50,000 g/mol.

### TECHNICAL FIELD OF THE INVENTION

The present invention relates to water-soluble films. More particularly, water-soluble films having more than one water-soluble polyvinyl alcohol resin and having the desired forming and sealing properties. The invention further relates to water-soluble packages comprising water-soluble films, especially polyvinyl alcohol resin.

### BACKGROUND OF THE INVENTION

Current commercially available water-soluble films used for complex multi-chamber thermoforming processes, for example in the manufacture of water-soluble automatic dishwashing (ADW) capsules, are mainly produced via an aqueous solution cast process. This process enables a water content in the film of greater than 3% which, by acting as a plasticiser, provides elasticity to the film.

Additionally, in such cast solution processes polyvinyl alcohol-polycarboxylate-polyvinyl acetate copolymer resins can be used. These polymers provide more freedom in adjusting properties compared to polyvinyl alcohol homopolymers. However, these copolymers cannot be used in extrusion processes as they tend to decompose due to high melt temperatures. Moreover, the process also requires a high amount of energy needed to dissolve all solid materials and then to evaporate the water. Moreover, manufacturing facilities require vast space due to the drying step.

There are also water-soluble films available which are produced from blown extrusion processes. These films are mainly used for applications such as shrink-wrap as it is difficult to control the blown process in such a way that the required homogenous thickness needed for thermoforming can be achieved. Water-soluble films processed using blown extrusion are exposed to two to three thermal stress steps, namely blending the solids and liquids under high shear forces and compounding the material in an extruder, before the composition is melted to manufacture the film. A further difficulty and restriction of blown extrusion processes is that it is difficult to blend into the water-soluble film a high level of liquid plasticizer.

One of the aims of embodiments of the present invention is to overcome these restrictions and develop an extruded water-soluble film which possesses the desired properties for subsequent thermoforming into suitable packaging for ingredients.

In order for the film to be suitable for thermoforming and possess the desired properties it must be suitable for being exposed to thermoforming temperatures which enable elastic re-shrinking, while being exposed to forming vacuum levels of 200-950 mbar for less than 3s in the forming step: the film must have chemical and physical robustness. This ensures that in the case of thermoformed packaging that there is no accidental contact by the consumer with any ingredients within the packaging: which is especially important with detergent packaging, where contact with active detergent ingredients during normal usage should be avoided: the film should achieve a sealing strength above 20N (as determined by a tensile tester pulling apart a sealed test specimen) or above 300N (as determined by a compression force tester); and the film should exhibit long term sealing stability against thermal degradation in order to prevent leakage of the active composition.

To ensure a suitable mechanical stability during the heat-sealing process, it is known that high weight average molecular weight polymers are needed. Unfortunately, these polymers display a high melt viscosity which provides challenges during the cast extrusion. Moreover, films comprising high weight average molecular weight polymers alone have been observed to not possess the elastic properties required for the thermoforming process.

Water-soluble films comprising a high weight average molecular weight polyvinyl alcohol resin with a lower content of liquid plasticizer have shown insufficient forming behaviour in multi-compartment products.

EP2529002 describes a combination of different high weight average molecular weight polyvinyl alcohol resins in a film. However, EP2529002 does not disclose the presence of a low weight average molecular weight polyvinyl alcohol resins nor does it describe a direct extrusion process. As noted above, high weight average molecular weight polyvinyl alcohol resins display a high melt viscosity which provides challenges during a cast extrusion process. Moreover, high weight average molecular weight polyvinyl alcohol resins don't have the elastic properties required for the thermoforming process. Consequently, EP2529002 does not have the desired film properties of the present invention.

The present invention aims to solve the above-mentioned problems by providing a water-soluble film with a reduced melt viscosity and the desired elastic properties, in addition to an increased robustness suitable for the thermal sealing process. Moreover, it is an aim of the present invention to develop a water-soluble film having a high sealing strength and improved forming properties.

It is also an aim of embodiments of the present invention to provide an improved process for manufacturing a water-soluble film.

It is furthermore an aim of embodiments of the invention, to provide an improved water-soluble package comprising a water-soluble film.

It is also an aim of embodiments of the invention to overcome at least one problem of the prior art, whether expressly disclosed herein or not.

### SUMMARY OF THE INVENTION

According to a first aspect of the present invention, there is provided a water-soluble film comprising more than one polyvinyl alcohol resin, and at least one plasticiser present in an amount of at least 20% by weight of the film, wherein at least one polyvinyl alcohol resin has a weight average molecular weight of at least 50,000 g/mol and at least one polyvinyl alcohol resin has a weight average molecular weight of less than 50,000 g/mol.

As the water-soluble film has at least one polyvinyl alcohol resin with a weight average molecular weight of at least 50,000 g/mol and at least one polyvinyl alcohol resin with a weight average molecular weight of less than 50,000 g/mol, and a plasticiser present in an amount of at least 20% by weight of the film, the water-soluble film has a reduce melt viscosity while possessing the desired elastic properties, in addition to an increased robustness suitable for the thermal sealing process.

Surprisingly, it was also discovered that the film according to the present invention possesses a higher sealing strength and better forming properties when compared with a water-soluble not possessing the combination of different weight average molecular weight polyvinyl alcohol resins and a low amount of plasticiser.

The term ‘water-soluble’ is used herein to refer to a material which and at least partially dissolves or disperses in water at 20° C. within 10 minutes. The term ‘water-soluble package’ is used herein to refer to a package which at least partially disperses, disintegrates or ruptures in water at 20° C. within 10 minutes to allow for egress of the contents of the package into the surrounding water.

All weight average molecular weights described herein are determined by gel permeation chromatography.

At least one polyvinyl alcohol resin may have a weight average molecular weight of at least 60,000, 70,000, 80,000, 90,000 or at least 100,000 g/mol.

At least one polyvinyl alcohol resin may have a weight average molecular weight of 50,000-150,000 g/mol, or 60,000-140,000 g/mol, or 70,000-130,000 g/mol, 80,000-120,000 g/mol, or most preferably 90,000-110,000 g/mol.

Beneficially, the presence of at least one polyvinyl alcohol resin having a weight average molecular weight of at least 50000 g/mol ensures a suitable mechanical stability during the heat-sealing process.

At least one polyvinyl alcohol resin may have a weight average molecular weight of no more than 48,000, 46,000, or no more than 45,000 g/mol.

At least one polyvinyl alcohol resin may have a weight average molecular weight of 20,000-50,000 g/mol, or 25,000-50,000 g/mol, or 30,000-50,000 g/mol, or most preferably 35,000-50,000 g/mol.

Beneficially, the presence of at least one polyvinyl alcohol resin having a weight average molecular weight of less than 50,000 g/mol enables a reduction in the melt viscosity and provides the desired elastic properties, in addition to an increased robustness suitable for the thermal sealing process.

The polyvinyl alcohol resin may be cold-water soluble. For example, the polyvinyl alcohol resin may be soluble at a temperature of 20° C.

The polyvinyl alcohol resin may have a degree of hydrolysis of from 60%-99%, preferably from 80%-99%, even more preferably from 80%-90%, most preferably 87%-89%. Beneficially, this improves the dissolution characteristics of the material. As used herein, the degree of hydrolysis is expressed as a percentage of vinyl acetate units converted to vinyl alcohol units.

It is known that the viscosity of polyvinyl alcohol resins is correlated with the weight average molecular weight of the polyvinyl alcohol resin. Consequently, references to the advantages of the specific weight average molecular weight combinations of the water-soluble films of the present invention also apply to the effects of the combination of different viscosity polyvinyl alcohol resins on the same properties.

All viscosities specified herein in Centipoise (cP) refer to the viscosity of 4% aqueous polyvinyl alcohol solution at 20° C.

At least one polyvinyl alcohol resin having a weight average molecular weight of at least 50,000 g/mol may have a viscosity of at least 7 cP. Preferably, at least one polyvinyl alcohol resin having a weight average molecular weight of at least 50,000 g/mol has a viscosity of 10-25 cP, most preferably 15-21.

At least one polyvinyl alcohol resin having a weight average molecular weight of less than 50,000 g/mol may have a viscosity of less than 7 cP. Preferably, at least one polyvinyl alcohol resin having a weight average molecular weight of less than 50,000 g/mol has a viscosity of 4.0-6.5 cP.

The polyvinyl alcohol resin may be present in an amount of from 60%-85% by weight of the film. Preferably, the polyvinyl alcohol resin is present in an amount of from 70-80% by weight of the film.

The ratio of the at least one polyvinyl alcohol resin having a weight average molecular weight of at least 50,000 g/mol and the at least one polyvinyl alcohol resin having a weight average molecular weight of less than 50,000 g/mol may be from 1:1 to 12:1, or from 1:1 to 9:1, 1:1 to 8:1, 1:1 to 7:1, 1:1 to 6:1, 1:1 to 5:1, 1:1 to 4:1, 1:1 to 3:1, 1:1 to 2:1, or preferably from 2:1 to 2.75:1.

Preferably, the ratio of the at least one polyvinyl alcohol resin having a weight average molecular weight of at least 50,000 g/mol and the at least one polyvinyl alcohol resin having a weight average molecular weight of less than 50,000 g/mol ratio is 2.75:1.

The plasticiser may be a liquid plasticiser at room or ambient temperature. For example, the plasticiser may be a liquid at about 20-25° C.

By “liquid at room or ambient temperature” it is meant that the melting point of the plasticiser at a pressure of 1 atmosphere is less than or equal to about 20-25° C.

Surprisingly, it was discovered that the use of a liquid plasticiser improves the forming properties and sealing strength of the resulting films.

The plasticiser may be selected from the group consisting of glycerol and derivatives thereof, a C₂-C₆ alkylene glycol and derivatives thereof, polyalkylene glycols, esters of carboxylic acids, and any two or more combinations thereof.

Examples of C₂-C₆ alkylene glycols suitable for use in the present invention include but are not limited to ethylene glycol, 1,2 propylene glycol, 1,3 propylene glycol, butylene glycol, pentylene glycol, and hexylene glycol. Examples of polyalkylene glycols include but are not limited to polyethylene glycol, and polypropylene glycol.

Examples of esters of carboxylic acids include but are not limited to esters of citric acid, malic acid, maleic acid or succinic acid.

The plasticiser may be present in an amount of at least 21%, 22%, 23%, 24% or at least 25%, and is preferably present in an amount of between 20-35% by weight of the film.

The liquid plasticiser may be present in an amount of at least 21%, 22%, 23%, 24% or at least 25%, and is preferably in an amount of 20-35% by weight of the film.

Beneficially, a high plasticiser content of 20-35% by weight of the film improves the forming properties of the film. This is thought to be due to the plasticiser decreasing the glass transition temperature and therefore providing flexibility to the film.

The film may comprise more than one plasticiser. Preferably, the film may comprise a blend of plasticisers.

Preferably, the film comprises a blend of glycerol and 1,2 propylene glycol.

It was surprisingly discovered that when the film comprises more than one plasticiser, particularly a blend of glycerol and an alkylene glycol (such as 1,2, propylene glycol) the sealing strength of the film is increased. Without being bound by theory, it is thought that this is due to the interaction of the polyvinyl alcohol hydroxyl groups with the different molecular sizes of plasticiser.

The ratio of the blend of plasticisers, such as a blend of glycerol and 1,2 propylene glycol, may be from 1:1 to 8:1, such as between 2:1 and 6:1, most preferably 4:1.

The water-soluble film may further comprise a plasticiser which is solid at room or ambient temperature.

By “solid at room or ambient temperature” it is meant that the melting point of the plasticiser at a pressure of 1 atmosphere is greater than about 20-25° C.

Suitable solid plasticisers are solid or waxy at ambient temperature. Suitable solid plasticisers include solid polyols and other carbohydrates

Carbohydrates are usually represented by the generalised formula Cx(H2O)y. The term herein also includes materials which are similar in nature like gluconic acids or amino sugars which cannot be fully represented by this formula.

Suitable solid polyols include sugar alcohols such as sorbitol, glucitol, mannitol, galactitol, dulcitol, xylitol, erythritol, pentaerythritol, isomaltose and isomalt.

The water-soluble film may comprise one layer or a plurality of layers.

The water-soluble film may further comprise one or more processing aids. Suitable processing aids include mono-, di-, tri-carboxylic acids/salts thereof, fatty acids such as stearic acid/salts thereof, mono-, di- or triglycerides/salts thereof, fumed silica and inorganic and organic pigments.

An anti-blocking agent may also be present in the film. Suitable anti-blocking agents include silica, talcum, zeolites and starch.

In a second aspect of the present invention, there is provided a direct cast extrusion process for producing a water-soluble film comprising more than one polyvinyl alcohol resin and at least one plasticiser present in an amount of at least 20% by weight of the film, wherein at least one of the polyvinyl alcohol resins has a weight average molecular weight of at least 50,000 g/mol and at least one of the polyvinyl alcohol resins has a weight average molecular weight of less than 50,000 g/mol.

Surprisingly, it was discovered that producing a water-soluble film according to the present invention in a direct cast extrusion process enables the extrusion of a film with good transparency and no or a very low level of unmolten particles.

The direct cast extrusion process may comprise the steps of:
a) providing at least one polyvinyl alcohol resin having a weight average molecular weight of at least 50,000 g/mol and at least one polyvinyl alcohol resin having a weight average molecular weight of less than 50,000 g/mol into an extruder;
b) combining the polyvinyl alcohol resins with at least one plasticiser in the extruder to form a mixture;
c) extruding the mixture through a die to form a water-soluble composition comprising more than one polyvinyl alcohol resin and at least one plasticiser present in an amount of at least 20% by weight of the composition, wherein at least one of the polyvinyl alcohol resins has a weight average molecular weight of at least 50,000 g/mol and at least one of the polyvinyl alcohol resins has a weight average molecular weight of less than 50,000 g/mol; and
d) forming a water-soluble film from the water-soluble composition.

Steps c) and d) may be combined to provide a single step c) which comprises extruding the mixture formed in step b) through a die to form a water-soluble film comprising more than one polyvinyl alcohol resin and at least one plasticiser present in an amount of at least 20% by weight of the film, wherein at least one of the polyvinyl alcohol resins has a weight average molecular weight of at least 50,000 g/mol and at least one of the polyvinyl alcohol resins has a weight average molecular weight of less than 50,000 g/mol.

Alternatively step c) may comprise extruding a melt which is subsequently processed in step d) to form the film. In such embodiments, step c) may comprise forming a plurality of pellets or granules of the water-soluble mass, and step d) may comprise forming the pellets or granules into a film.

The pellets or granules may be formed by extruding the water-soluble melt, in the form of at least one rope, through a die plate comprising at least one aperture and cutting the or each rope into pellets or granules using a cutting blade or blades, which may be a rotating cutting blade or blades.

The pellets or granules may be passed through a second extruder, which may be a single or twin-screw extruder for example, to form a film.

In a third aspect of the present invention, there is provided a water-soluble package comprising a water-soluble film according to the present invention. The water-soluble package may be produced using a method of the second aspect of the invention.

In a fourth aspect of the invention there is provide a water-soluble package of the third aspect of the invention, containing a composition.

In a fifth aspect of the invention there is provided a process for preparing a water-soluble package, the process comprising:
a) thermoforming a first film of the present invention to produce at least one pocket;
b) at least partially filling the or each pocket with a composition; and
c) placing a second film, preferably a polyvinyl alcohol film, on top of the or each filled pocket; and
d) sealing the first film and second film together.

In some embodiments the second film is also a film of the present invention.

The pocket may comprise a flange or rim, and the second film may be sealed to the first film at least on the flange or rim.

The composition may be placed in the pocket in step b) and the second film placed on the flange or rim and across the pocket.

Step a) may comprise thermoforming more than one pocket in the film, such as two, three or four pockets. Each pocket may be filled with a different composition, the same composition, or any combination of compositions.

The or each pocket may be completely filled with a composition in step b). Partial filling of each pocket may reduce the risk of rupture of the package, if the package is subjected to shock, and may reduce the risk of leakage if the package is subject to high temperatures.

The films are sealed together in step d), for example by heat sealing across a flange or rim. A suitable heat-sealing temperature is, for example between 120 to 195° C., such as 140 to 190° C. A suitable sealing pressure is, for example, from 250 to 800 kPa. Examples of sealing pressures are 276 to 552 kPa (40 to 80 p.s.i.), especially 345 to 483 kPa (50 to 70 p.s.i.) or 400 to 800 kPa (4 to 8 bar), especially 500 to 700 kPa (5 to 7 bar) depending on the heat-sealing machine used. Suitable sealing dwell times are at least 0.4 seconds, for example 0.4 to 2.5 seconds. Other methods of sealing the films together may be used, for example infrared, radio frequency, ultrasonic, laser, solvent, vibration, electromagnetic, hot gas, hot plate, insert bonding, fraction sealing or spin welding. An adhesive, such as water or an aqueous solution of polyvinyl alcohol may also be used. The adhesive can be applied to the films by spraying, transfer coating, roller coating or otherwise coating, or the films can be passed through a mist of the adhesive. The seal desirably is also water-soluble.

The first film of the invention may generally have a thickness before thermoforming of 20 to 500 μm, especially 70 to 400 μm, for example 70 to 300 μm, most preferably 70 to 160 μm, especially 80 to 150 μm. The thickness of the second film may be less than that of the first film as the second film may not generally be thermoformed, so localised thinning of the sheet may not occur. The thickness of the second film may generally be from 20 to 150 μm, preferably from 40 to 90 or 100 μm, more preferably from 50 to 80 μm. However, a film having a thickness of 70 to 150 μm may also be used.

The films may be chosen, if desired, such that the first film may have a thickness greater than the thickness of the second film before the first film is thermoformed. In such an embodiment the first film may have a thickness of less than the thickness of the second film after the first film is thermoformed.

The composition filling the packages is not particularly limited. It can be any composition which is to be added to an aqueous system or used in an aqueous environment.

The composition may be a dishwashing, water-softening, laundry or detergent composition or a rinse aid. In this case it is especially suitable for use in a domestic washing machine such as a laundry washing machine or, especially, a dishwashing machine, including an automatic dishwashing machine.

The nature of the composition in each pocket is not limited. It may, for example, be independently a solid or a liquid in each pocket. If it is in the form of a solid it may, for example, be in the form of a powder, granules, an extruded tablet, a compressed tablet or a solidified gel. If it is in the form of a liquid, it may be optionally thickened or gelled with a thickener or a gelling agent. One or more than one phase may be present. For example, each pocket may be independently filled with a liquid composition and a separate solid composition, for example in the form of a ball, pill, granules or speckles. Alternatively, two or more solid phases may be present, or two or more immiscible liquid phases.

Thus, the composition in each pocket need not be uniform. For example, during the manufacture at least one pocket could first be filled with a settable composition, for example a gel, and then with a different composition such as a liquid, especially an aqueous, composition, or the compositions could be filled in separate pockets. The first composition could dissolve slowly, for example in a washing process, so as to deliver its charge over a long period. This might be useful, for example, to provide an immediate, delayed or sustained delivery of a component such as a softening agent.

If more than one package is formed at the same time, the packaged compositions may then be separated from each other.

Alternatively, they may be left conjoined, and, for example, perforations provided between the individual packages so that they can be easily separated at a later stage, for example by a consumer or during further processing of the packages.

If the packages are separated, the flanges may be left in place. However, desirably the flanges are partially removed in order to provide an even more attractive, three-dimensional appearance. Generally, the flange remaining should be as small as possible for aesthetic purposes while bearing in mind that some flange is required to ensure the two films remain adhered to each other. A flange of 0.1 mm to 5 mm is desirable, preferably 0.5 mm to 4 mm, more preferably 1 mm to 3 mm, most preferably about 2 mm.

The packages may then be left to absorb water from the atmosphere or may be immediately packaged into boxes for retail sale. The packages may themselves be packaged in outer packages if desired, for example non-water-soluble outer packaging material which is removed before the water-soluble packages are used.

The packages of the present invention generally contain from 5 to 100 g of composition, such as an aqueous composition, especially from 15 to 40 g, depending on their intended use. For example, a dishwashing composition may weigh from 9 to 20 g, a water-softening composition may weigh from 10 to 40 g, and a laundry composition may weigh from 10 to 40 g, especially 10 to 30 g.

The pockets may have any shape. For example, they can take the form of an envelope, sachet, sphere, hemisphere, segment of a sphere, cylinder, cube (including rounded cubes) or cuboid (including rounded cuboids), i.e. a rectangular parallelepiped whose faces are not all equal: or an irregular shape. In general, because the packages are not rigid and are inflated, the sides are not planar, but rather are convex. If the package is formed from a thermoformed film and a planar film, the seam between the two films will appear nearer one face of the package rather than the other. Apart from the deformation of the package due to shrinkage of the polyvinyl alcohol films after the package is manufactured, deformation may also occur at the stage of manufacture if desired. For example, if the pocket is filled with a solid or gelled composition (for example in the form of a tablet) having a height greater than that of the pocket, the second film will be deformed when placed on top of the pocket.

In general, the maximum dimension of the filled part (pocket) of the package (excluding any flanges) is 10 cm×10 cm, preferably 8 cm×8 cm. For laundry detergent compositions, the maximum dimension of the filled part of the package is preferably 8 cm×8 cm, whilst for automatic dishwashing detergent compositions, the maximum dimension may be smaller, such as no more than 6 cm×6 cm, for example.

The composition may contain surface active agents such as anionic, nonionic, cationic, amphoteric or zwitterionic surface active agents or mixtures thereof.

Dishwashing compositions may comprise a detergency builder. The builder is preferably a phosphate-free builder. The builder may comprise one or more small molecule builders selected from hydroxycarboxylates (such as a citrate salt, for example trisodium citrate, which may be anhydrous), aminocarboxylates (such as methyl glycine diacetic acid (MGDA), or N,N-dicarboxymethyl glutamic acid (GLDA), dicarboxylic acid amines (such as iminodisuccinic acid (IDS) and/or phosphates (such as tripolyphosphate), or the salts thereof.

The compositions, particularly when used as laundry washing or dishwashing compositions, may also comprise enzymes, such as protease, lipase, amylase, cellulase and peroxidase enzymes.

The compositions may, if desired, comprise a thickening agent or gelling agent.

The compositions can also optionally comprise one or more additional ingredients. These include conventional detergent composition components such as further surfactants, bleaches, bleach activators, bleach catalysts, bleach enhancing agents, builders, suds boosters or suds, suppressors, anti-tarnish and anticorrosion agents, organic solvents, co-solvents, phase stabilisers, emulsifying agents, preservatives, soil suspending agents, soil release agents, germicides, pH adjusting agents or buffers, nonbuilder alkalinity sources, chelating agents, clays such as smectite clays, enzyme stabilizers, anti-limescale agents, colourants, dyes, hydrotropes, dye transfer inhibiting agents, brighteners and perfumes. If used, such optional ingredients will generally constitute no more than 10 wt. %, for example from 1 to 6 wt. %, of the total weight of the compositions.

Compositions which comprise an enzyme may optionally contain materials which maintain the stability of the enzyme. Such enzyme stabilizers include, for example, polyols such as propylene glycol, boric acid and borax. Combinations of these enzyme stabilizers may also be employed. If utilized, the enzyme stabilizers generally constitute from 0.1 to 1 wt. % of the compositions.

The compositions may optionally comprise components which adjust or maintain the pH of the compositions at optimum levels. Examples of pH adjusting agents are NaOH and citric acid. The pH may be from, for example, 1 to 13, such as 8 to 11 depending on the nature of the composition. For example, a dishwashing composition desirably has a pH of 8 to 11, a laundry composition desirably has a pH of 7 to 9, and a water-softening composition desirably has a pH of 7 to 9.

Preferably, the composition is an automatic dishwashing composition.

In a sixth aspect of the present invention, there is provided the use of a water-soluble film according to the present invention to package a composition as described herein.

In a seventh aspect of the present invention, there is provided the use of a water-soluble film according to the present invention to package a detergent or laundry composition, which composition may be as described hereinabove.

The further aspects of the present invention may incorporate any of the features of the other aspects of the invention described herein as desired or as appropriate.

### DETAILED DESCRIPTION OF THE INVENTION

In order that the invention may be more clearly understood, one or more embodiments thereof will now be described, by way of example only, in which:

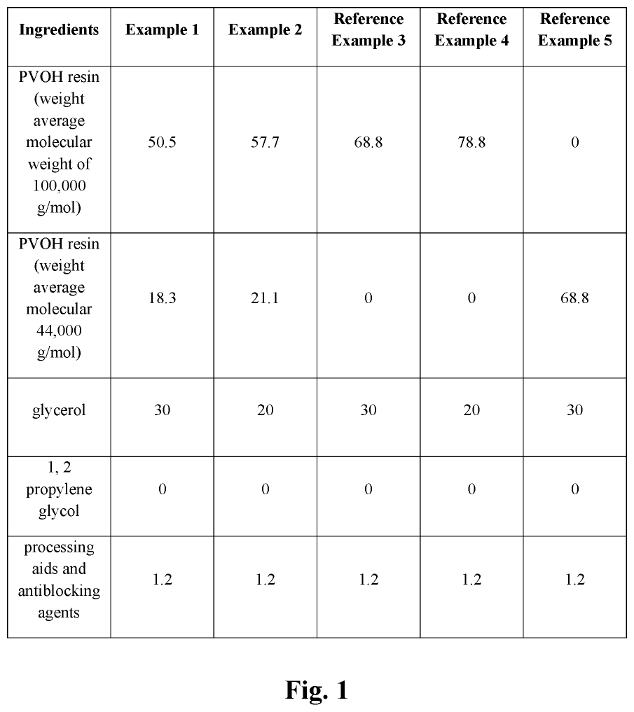

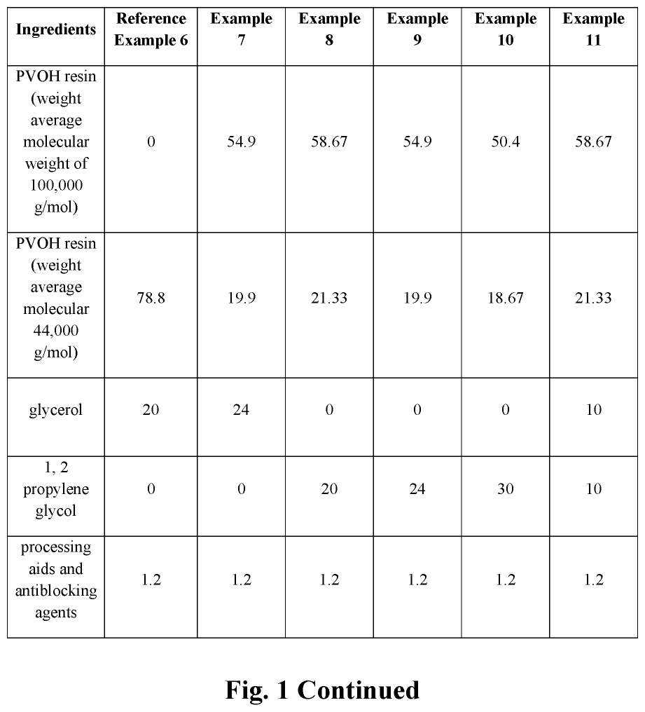

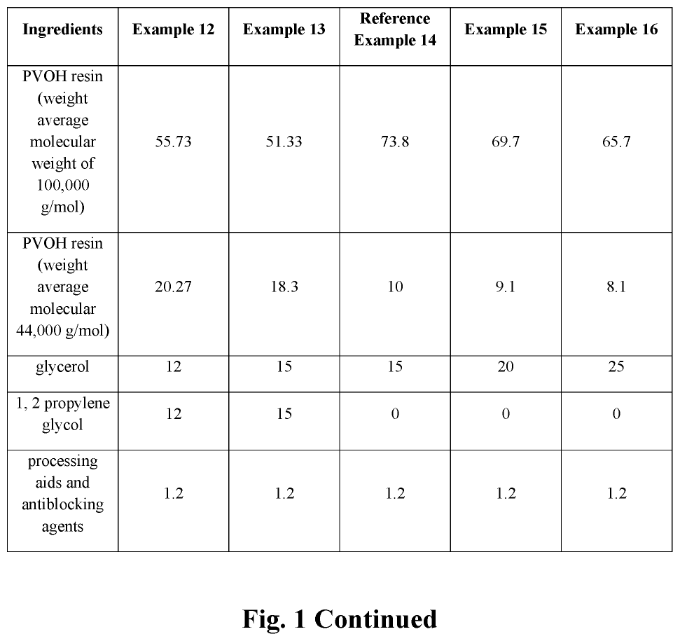

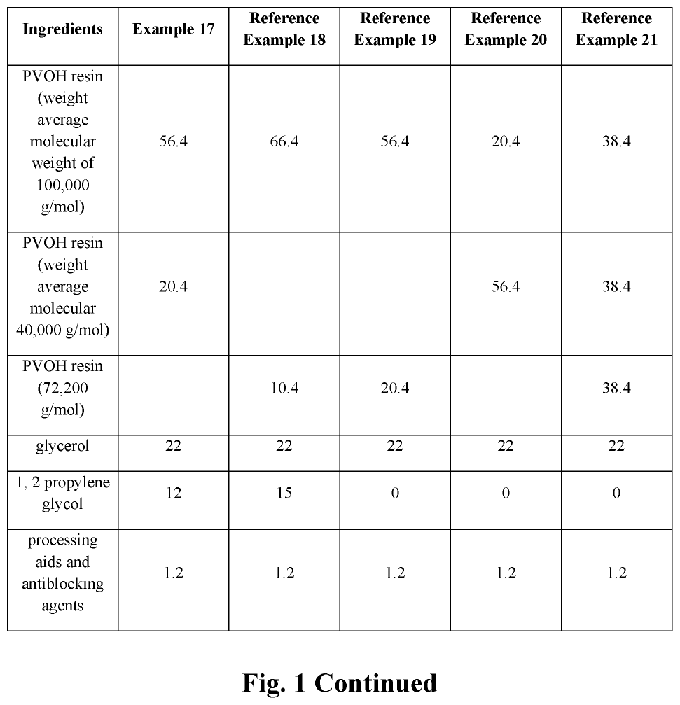

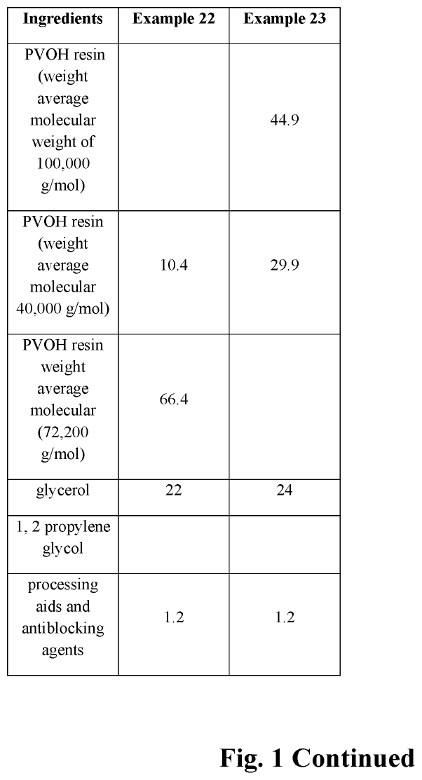

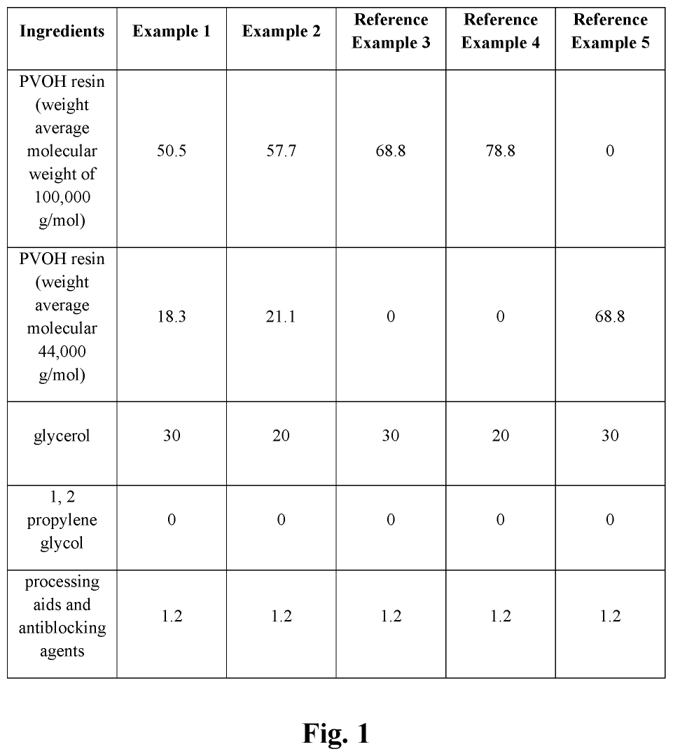

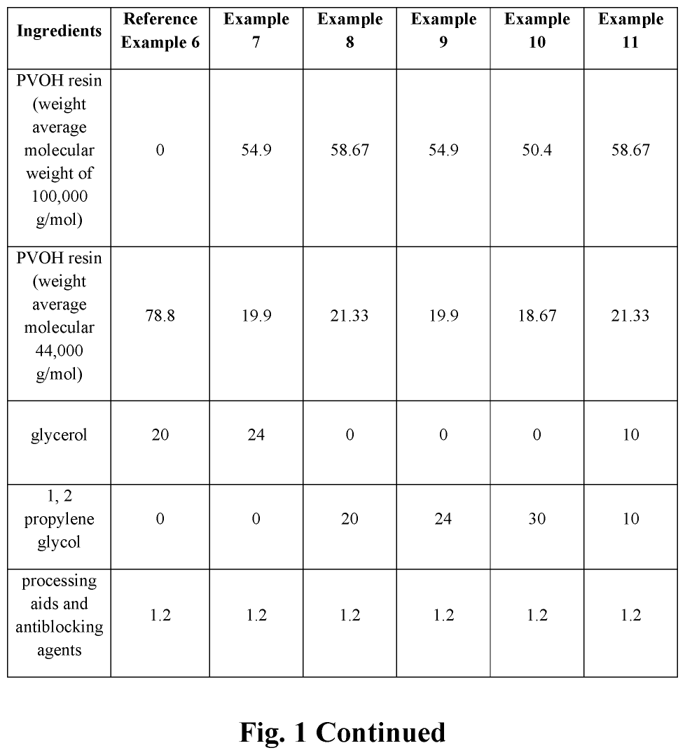

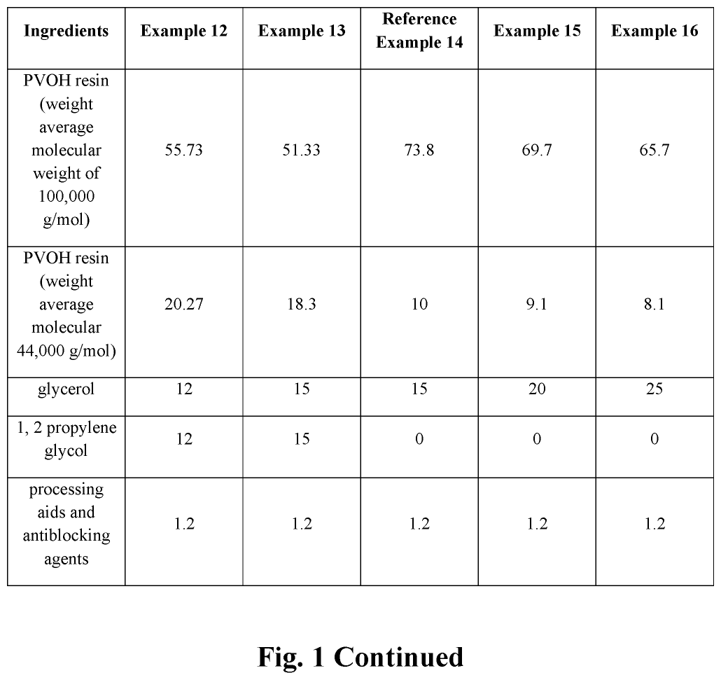

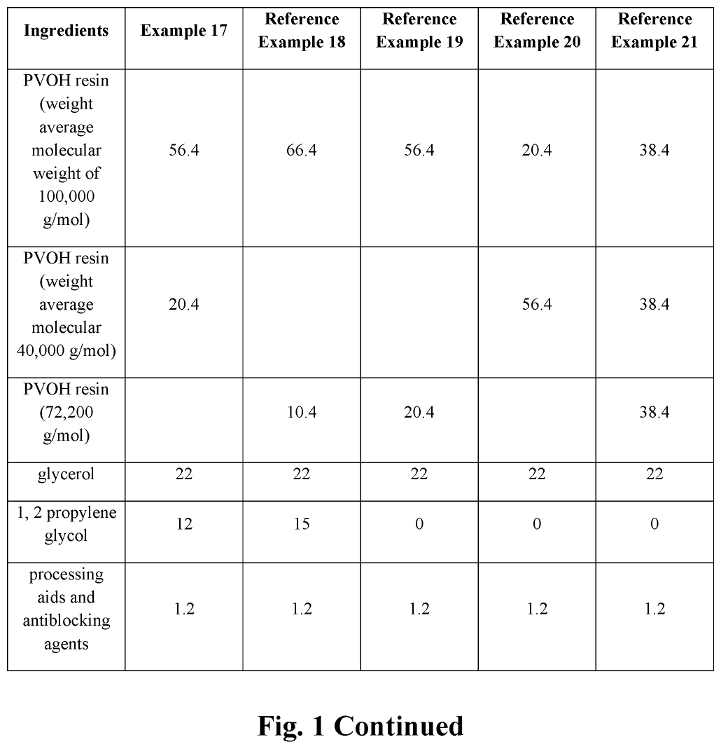

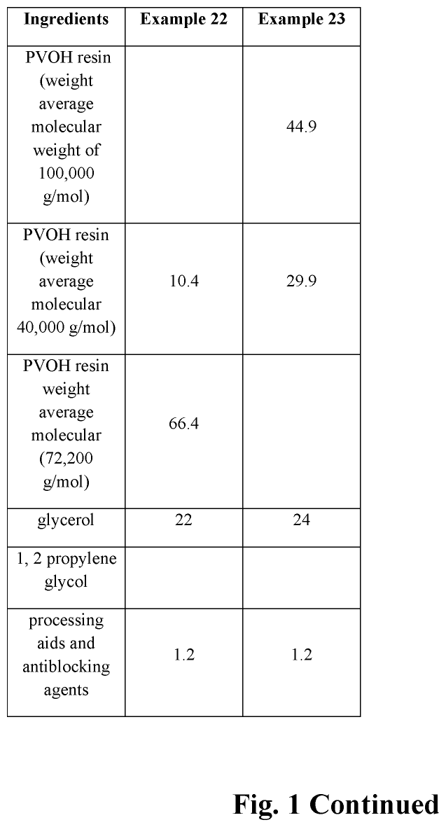

FIG. 1 is a table showing Examples of water-soluble films of the invention and Reference Examples of water-soluble films not of the invention.

### EXAMPLES

Water-soluble films of the invention and Reference Examples comprising water-soluble films not according to the invention were prepared as shown as Examples 1, 2, 7, 8, 9, 10, 11, 12, 13, 15, 16, 17, 22 and 23 and Reference Examples 3, 4, 5, 6, 14, 18, 19, 20 and 21 of FIG. 1.

### Sealing Strength Test

A test was devised in order to evaluate the sealing strength of water-soluble films of FIG. 1.

The water-soluble films of FIG. 1 were produced using a direct cast extrusion process of the invention using a twin screw extruder (ZK 25*42D, Diameter: 25 mm, Length [L/D]: 42 (7*6D)=1050 mm, speed: 300-600 rpm) having a 400 mm flat die.

The test involved sealing the water-soluble films together at 160° C. at 400 N pressure using a Brugger sealing device.

A sample, 15 mm×9 cm, was cut from the sealed film using a die and the sample placed in a Zwick tensile strength tester. The film was then pulled apart until the seal was broken, the force required to break the seal was recorded as maximum force.

The sealing strength test was performed to determine the effect of the polyvinyl alcohol weight average molecular weight on sealing strength.

The result of the sealing strength test are shown below in Table 1.

TABLE 1

| | | Amount of | Maximum Force |
|---|---|---|---|
| Example | Type of Plasticiser | Plasticiser (%) | (N) |
| Example 1 | Glycerol | 30 | 22.3 |
| Example 2 | Glycerol | 20 | 30.6 |
| Reference | Glycerol | 30 | 19.9 |
| Example 3 | | | |
| Reference | Glycerol | 20 | 29.9 |
| Example 4 | | | |
| Reference | Glycerol | 30 | 0 |
| Example 5 | | | |
| Reference | Glycerol | 20 | 25.7 |
| Example 6 | | | |

From Reference Examples 3 to 6, it can be seen that water-soluble films having only a single polyvinyl alcohol resin, whether high or low weight average molecular weight, have an acceptable sealing strength with the presence of a plasticiser in an amount of 20% by weight of the film.

In contrast, Reference Examples 3 to 6, show that films prepared with only a single polyvinyl alcohol resin are immediately broken when the film contains a plasticiser present in an amount of 30% by weight of the film.

Surprisingly, as can be seen from Examples 1 and 2, a film comprising both a polyvinyl alcohol resin with an average weight molecular weight of 100,000 g/mol and a polyvinyl alcohol resin with an average weight molecular weight of 44,000 g/mol delivers a film with a higher sealing strength values than for a film comprising only a single polyvinyl alcohol resin with an average weight molecular weight of 100,000 g/mol or 44,000 g/mol.

The Sealing strength test was also performed to determine the effect of the plasticiser on sealing strength.

The result of the sealing strength test are shown below in Table 2.

TABLE 2

| | | Amount of | Maximum Force |
|---|---|---|---|
| Example | Type of Plasticiser | Plasticiser (%) | (N) |
| Example 2 | Glycerol | 20 | 30.6 |
| Example 7 | Glycerol | 24 | 22.4 |
| Example 1 | Glycerol | 30 | 22.3 |
| Example 22 | Glycerol | 22 | 28.5 |
| Example 8 | 1,2 propylene | 20 | 26.5 |
| | glycol | | |
| Example 9 | 1,2 propylene | 24 | 29.7 |
| | glycol | | |
| Example 10 | 1,2 propylene | 30 | 28.2 |
| | glycol | | |
| Example 11 | Glycerol and 1,2 | 20 | 30.6 |
| | propylene glycol | | |
| Example 12 | Glycerol and 1,2 | 24 | 33.1 |
| | propylene glycol | | |
| Example 13 | Glycerol and 1,2 | 30 | 34.0 |
| | propylene glycol | | |

From Table 2, it can be seen that films with glycerol alone as a liquid plasticiser (Examples 1, 2 and 7) show weaker seals with an increased amount of liquid plasticiser. Films prepared with 1,2 propylene glycol alone (Examples 8, 9 and 10) show a small increase in sealing strength when the amount of 1,2 propylene glycol is increased.

Surprisingly, the films comprising a blend of liquid plasticisers (Examples 11, 12 and 13) demonstrated the highest sealing strength in the tests.

### Forming Assessment Test

In order to determine the forming properties of the water-soluble films, a 90 μm film was placed on a three-compartment cavity under a forming plate set at various temperatures between 100 and 130° C. and a vacuum of 450 or 800 mbar was applied.

Each film was thermoformed into the desired shape and a visual assessment by a trained evaluator is used to evaluate the forming behaviour. When complete forming of the shape is observed a score of 0 is recorded, when no forming of the shape is observed a score of 8 is recorded.

The effect of the presence of a polyvinyl alcohol resin on the forming properties of the film was determined using the above forming assessment test.

The results of this test were recorded in Table 3.

TABLE 3

| Example | Cavity 1 | Cavity 2 | Cavity 3 |
|---|---|---|---|
| Reference | 0 | 4 | 3 |
| Example 3 | | | |
| Reference | 0 | 1 | 1 |
| Example 5 | | | |
| Example 17 | 0 | 1 | 0 |
| Example 22 | 0 | 0 | 0 |
| Reference | 2 | 6 | 5 |
| Example 18 | | | |
| Reference | 2 | 5 | 2 |
| Example 19 | | | |
| Example 1 | 0 | 0 | 0 |

As shown in the above table, a water-soluble film according to the present invention having at least one polyvinyl alcohol resin having a weight average molecular weight of at least 50,000 g/mol and at least one polyvinyl alcohol resin having a weight average molecular weight of less than 50,000 g/mol demonstrates improved forming properties when compared with films comprising either a low weight average molecular weight polyvinyl alcohol resin or high weight average molecular weight polyvinyl alcohol resin alone.

Reference Examples 20 and 21 could not provide a suitable film due to the presence of a lot of holes and particles, which have not allowed to process such a material in a proper way.

The above forming assessment test was also used to determine the effect of the amount of plasticiser on the forming properties of the film. The results of this test are shown in Table 4.

TABLE 4

| | Forming Plate | | | |
|---|---|---|---|---|
| | Temperature | | | |
| Example | (° C.) | Cavity 1 | Cavity 2 | Cavity 3 |
| Example 1 | 100 | 0 | 0 | 0 |
| | 110 | 0 | 0 | 0 |
| | 120 | 0 | 0 | 0 |
| Example 7 | 100 | 0 | 0 | 0 |
| | 110 | 0 | 0 | 0 |
| | 120 | 0 | 0 | 0 |
| Reference | 110 | 0 | 3 | 4 |
| Example 14 | 120 | 0 | 3 | 4 |
| | 130 | 0 | 3 | 4 |
| Example 15 | 110 | 0 | 3 | 4 |
| | 120 | 0 | 1 | 2 |
| | 130 | 0 | 0 | 0 |
| Example 16 | 110 | 0 | 1 | 2 |
| | 120 | 0 | 0 | 0 |
| | 130 | 0 | 0 | 0 |

As shown in the above table, it can be seen that an increase in the amount of a plasticiser starting at 20% by weight of the film, provides improved forming properties, particularly at higher temperatures.

### Frame Dissolution Test

In order to determine the dissolution properties of a water-soluble film of the invention, a 45×37 mm sample of the film of Example 2 was placed in a frame, which was then added to 800 mL of water stirred at room temperature. The time taken for a hole in the sample to appear is recorded as well as the time for the complete water-soluble film sample to dissolve.

The result of this test is shown in Table 5.

TABLE 5

| | Time taken for | Complete dissolution |
|---|---|---|
| Example | appearance of 1^{st} hole (s) | time (s) |
| Example 2 | 32 | 287 |
| Example 23 | | 270 |
| Example 17 | | 300 |
| Example 22 | | 132 |
| Reference Example 4 | | 395 |
| Reference Example 18 | | 381 |
| Reference Example 19 | | 429 |

From Table 5 it can be seen that a water-soluble film according to the present invention has a suitable dissolution time, especially for use in detergent applications.

In summary, from the results shown in Tables 1-4, it can be seen that a water-soluble film according to the present invention has improved forming properties and sealing strength, whilst maintaining good dissolution properties.

In contrast, it can be seen that a water-soluble film comprising only a single polyvinyl alcohol resin, especially comprising a low amount of liquid plasticiser compromises on crucial properties, e.g., the film may exhibit high sealing strength but will not be formable; or vice versa. Only a film according to the present invention delivers all of the desired properties.

### Storage Properties

Multi-compartment detergent pouches with a film according to the present invention and a film containing only a single polyvinyl alcohol resin having a weight average molecular weight of greater than 50,000 g/mol were prepared via thermoforming (and heat sealing) and stored in doypacks filled with 30 pouches each for 6 weeks at various conditions.

The maximum compression force of a compartment containing a gel was measured until bursting of the compartment. An average maximum compression force was recorded from 20 measurements. The results are shown in Table 6.

TABLE 6

| Conditions | Film A | Film B |
|---|---|---|
| 25° C at 50% relative humidity. | 495N | 228N |
| 30° C. at 65% relative humidity | 539N | 168N |

In the above table, film A comprises a combination of a polyvinyl alcohol resin having a weight average molecular weight of greater than 50,000 g/mol and a polyvinyl alcohol resin having a weight average molecular weight of less than 50,000 g/mol. In addition, film A comprises 24% glycerol and 1.2% processing aids and antiblocking agents. In contrast, film B comprises only a polyvinyl alcohol resin having a weight average molecular weight of greater than 50,000 g/mol. Film B further comprises 24% glycerol and 1.2% processing aids and antiblocking agents.

From the results in Table 6, it can be seen that a film according to the present invention demonstrated improved storage stability when compared to a film not according to the present invention after storage for 6 weeks, with the pouch films displaying significantly less degradation.

### Preparation of a Water-Soluble Package

The film of the present invention, as set out in Example 1 and 2 was tested on a thermoformer using 3-compartment cavities to prepare a water-soluble detergent package.

In a first step, the film was placed over the cavity and below a heating plate. The heating plate was then brought into contact with the film and a forming vacuum was applied. For the remaining process steps a holding vacuum was applied to keep the film in the cavity. The three compartments were filled with the desired detergent compositions and a sealing film of the same composition was placed over the filled cavities. A heated sealing plate was then pressed onto the sealing flanges causing the top and bottom film to be welded together. After the sealing step the package was cut and the holding vacuum was stopped to allow the removal of the package from the cavity.

The water-soluble films of the invention formed detergent packages with no apparent defects and with excellent formed and sealing properties; and as set out in Table 5 the dissolution properties were suitable for automatic dishwashing or laundry applications.

It is of course to be understood that the present invention is not intended to be restricted to the foregoing examples which are described by way of example only.

1. A water-soluble film comprising more than one polyvinyl alcohol resin and at least one plasticiser present in an amount of at least 20% by weight of the film, wherein at least one polyvinyl alcohol resin has a weight average molecular weight of at least 50,000 g/mol and at least one polyvinyl alcohol resin has a weight average molecular weight of less than 50,000 g/mol.

2. A film according to claim 1, wherein the plasticiser is a liquid at room or ambient temperature and/or wherein the plasticiser is present in an amount of from 20-35% by weight of the film.

3. A film according to any preceding claim, wherein the polyvinyl alcohol resin has a degree of hydrolysis of from 80%-90%.

4. A film according to any preceding claim, wherein the plasticiser is selected from the group consisting of: glycerol and derivatives thereof; a C₂-C₆ alkylene glycol and derivatives thereof, preferably 1,2 propylene glycol:polyalkylene glycols:esters of carboxylic acids, preferably esters of citric acid, malic acid, maleic acid or succinic acid; and/or any two or more combinations thereof.

5. A film according to any preceding claim, wherein the film comprises more than one plasticiser; wherein the film comprises preferably two plasticisers; wherein more preferably the ratio of the plasticisers is from 1:1 to 8:1.

6. A film according to any preceding claim, wherein the ratio of the polyvinyl alcohol resin having a weight average molecular weight of at least 50,000 g/mol and the at least one polyvinyl alcohol resin having a weight average molecular weight of less than 50,000 g/mol is from 1:1 to 12:1.

7. A direct cast extrusion process for producing a water-soluble film comprising more than one polyvinyl alcohol resin and at least one plasticiser present in an amount of at least 20% by weight of the film, wherein at least one polyvinyl alcohol resin has a weight average molecular weight of at least 50,000 g/mol and at least one polyvinyl alcohol resin has a weight average molecular weight of less than 50,000 g/mol.

8. A process according to claim 7, wherein the polyvinyl alcohol resin has a degree of hydrolysis of from 80%-90%.

9. A process according to any of claims 7-8, wherein the plasticiser is a liquid at room temperature.

10. A process according to any of claims 7-9, wherein the process comprises the steps of:
a) providing at least one polyvinyl alcohol resin having a weight average molecular weight of at least 50,000 g/mol and at least one polyvinyl alcohol resin having a weight average molecular weight of less than 50,000 g/mol into an extruder;
b) combining the polyvinyl alcohol resins with at least one plasticiser in the extruder to form a mixture;
c) extruding the mixture through a die to form a water-soluble composition comprising more than one polyvinyl alcohol resin and at least one plasticiser present in an amount of at least 20% by weight of the composition, wherein at least one of the polyvinyl alcohol resins has a weight average molecular weight of at least 50,000 g/mol and at least one of the polyvinyl alcohol resins has a weight average molecular weight of less than 50,000 g/mol; and
d) forming a water-soluble film from the water-soluble composition.

11. A process according to claim 7, wherein steps c) and d) are combined to provide a single step c) which comprises extruding the mixture formed in step b) through a die to form a water-soluble film comprising more than one polyvinyl alcohol resin and at least one plasticiser present in an amount of at least 20% by weight of the film, wherein at least one of the polyvinyl alcohol resins has a weight average molecular weight of at least 50,000 g/mol and at least one of the polyvinyl alcohol resins has a weight average molecular weight of less than 50,000 g/mol; wherein preferably step c) comprises forming a plurality of pellets or granules of the water-soluble mass, and step d) comprises forming the pellets or granules into a film; and wherein more preferably the pellets or granules are passed through a second extruder, and wherein the second extruder is optionally a single or twin-screw extruder, to form a film.

12. A process according to claim 7, wherein step c) comprises extruding a melt which is subsequently processed in step d) to form the film: wherein preferably the pellets or granules are formed by extruding the water-soluble melt in the form of at least one rope through a die plate comprising at least one aperture and cutting the or each rope into pellets or granules using a cutting blade or blades, which may be a rotating cutting blade or blades: or wherein preferably the pellets or granules are passed through a second extruder, and wherein the second extruder is optionally a single or twin-screw extruder, to form a film.

13. A water-soluble package comprising a water-soluble film according to any of claims 1 to 6; wherein preferably the water-soluble package contains a composition: wherein more preferably the composition is an automatic dishwashing composition.

14. A process for preparing a water-soluble package, the process comprising:
a) thermoforming a first film according to any of claims 1 to 6 to produce at least one pocket;
b) at least partially filling the or each pocket with a composition; and
c) placing a second film, preferably a polyvinyl alcohol film, and more preferably a film according to any of claims 1 to 6, on top of the or each filled pocket; and
d) sealing the first film and second film together.

15. A use of a water-soluble film according to claims 1 to 6 to package a composition;
wherein preferably composition is an automatic dishwashing composition, detergent composition, or laundry composition.
